(19) United States
(12) Patent Application Publication
(10) Pub. No.: US 2010/0157749 A1
(43) Pub. Date: Jun. 24, 2010

(54) Information Recording/Reproducing Apparatus and Track Offset Adjusting Method of Information Recording Medium

(76) Inventors: Masatsugu Ogawa, Tokyo (JP); Shuichi Ohkubo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/087,880

(22) PCT Filed: Jan. 17, 2007
(86) PCT No.: PCT/JP2007/050554

§ 371 Date: Jul. 16, 2008

(30) Foreign Application Priority Data
Jan. 17, 2006 (JP) 2006-008514

(51) Int. Cl. G11B 7/00; G11B 20/00

(52) U.S. Cl. 369/44.11; 369/47.15; G9B/7; G9B/20

(57) ABSTRACT

In a track offset adjusting method of an information recording medium, data are recorded onto first and second tracks of an information recording medium. No data are recorded on at least one of tracks adjacent to each of the first and second tracks. After the data recording onto the first and second tracks, data are recorded onto the third track adjacent to the inner circumferential side of the first track and onto a fourth track adjacent to the outer circumferential side of the second track. Thereafter, reproduction signal qualities of the first and second tracks are calculated on the basis of reproduction signals obtained by reproducing the data recorded on said first and second tracks. The track offset is adjusted on the basis of the reproduction signal qualities of the first and second tracks.

### TECHNICAL FIELD

The present invention relates to an information recording/reproducing apparatus and a track offset adjusting method of information recording mediums.

### BACKGROUND ART

A recordable optical disc is usually provided with a guide groove which allows an optical beam spot emitted from an optical head to scan. The optical beam spot is controlled to scan along the guide groove by using a servo technique. The technique for allowing the optical beam spot to scan along this guide groove is referred to as a tracking servo technique, and a signal for the tracking servo is referred to as a track error signal.

Ideally, there is no need for adding an offset voltage to the voltage level of the track error signal. However, various disturbance factors actually cause an offset to be generated in the track error signal, and therefore an information recording/reproducing apparatus often control the track error signal, providing an offset voltage for the track error signal in order to correct this offset. This offset voltage is usually referred to as a track offset.

Problems caused by an inappropriate track offset value include a cross erasure of record marks. The cross erasure is a phenomenon that, when the recording performed on a certain track causes erasure of a mark already recorded onto a track adjacent to the certain track. When the track offset does not have a proper value, the optical beam spot excessively approaches the adjacent track, promoting the cross erasure. Therefore, it is important to set the track offset to an optimal value. In optical discs related to DVDs (Digital Versatile Discs) which have been put in the market until now, the cross erasure caused by an inappropriate track offset has not caused a significant problem. However, in high density optical discs, such as HD DVDs (High Definition DVDs) and so on, in which the standardization has been advanced in recent years, the distance between the tracks is reduced, and therefore optimal setting of the track offset is an important issue.

As a method of setting the track offset optimal, methods disclosed in Japanese Laid Open Patent Applications No. JP-P2003-242670A, JP-P2000-200435A and JP-A-Heisei, 10-312554 are known.

Japanese Laid Open Patent Application JP-P2003-242670A discloses an adjusting method of the track offset for an optical disc of a land-groove format. In the land-groove format, record marks are formed on both of a groove portion (land) and an elevated portion (groove), when viewed from the optical beam spot of the guide groove. On the other hand, the format in which record marks are formed only on the groove portion is referred to as an in-groove format. According to Japanese Laid Open Patent Application No. JP-P2003-242670A, record marks are first recorded onto adjacent two groove (or land) tracks, and record marks are then formed on a land (or groove) track between the tracks. After that, the error rates of both of the groove (or land) tracks on which the record marks are firstly formed are measured. From the relation between the error rates, the state of the cross erasure is estimated, and the track offset is adjusted accordingly.

In this adjusting method, the error rate is used for adjusting the track offset. The error rate is locally increased when an optical disc has a defect such as a fault and the like, and the variation in the signal quality between the tracks is large. Therefore, it is impossible to judge whether the deterioration in the error rate is caused by the variation in the signal quality between the tracks or caused by the cross erasure, making it difficult to improve the adjustment precision of the track offset. Also, when there are both of a track into which cross erasures from both adjacent tracks are introduced and a track into which a cross erasure from one adjacent track is introduced, the influence degrees of the cross erasures between the measurement tracks is different, which disables the adjustment in the optical disc in which the cross erasure is severe.

Japanese Laid Open Patent Application No. JP-P2000-200435A discloses a method of adjusting the track offset through recording single cycle signals of different frequencies onto successive three tracks, and measuring the leakage of the single cycle signal from the adjacent track when a data is reproduced from the central track. This is an adjusting method of minimizing a crosstalk instead of the cross erasure. The crosstalk is a leakage of the signal from the adjacent track, resulting in the noise for the reproduced track, and therefore, the crosstalk is preferably reduced as small as possible.

However, in a high density optical disc, the optimal track offset from the viewpoint of the crosstalk is different from the optimal track offset from the viewpoint of the cross erasure, and therefore it is difficult to apply this method to the high density optical disc. For a high density optical disc, the cross erasure is often an issue, and therefore this method cannot actually achieve the optimal track offset adjustment.

Japanese Laid Open Patent Application No. JP-A-Heisei, 10-312554 discloses a method of performing track offset adjustment in accordance with the relation between the reproduction amplitude and the track offset. The optimal track offset position determined in accordance with the amplitude of a reproduction signal cannot improve the adjustment precision thereof. Also, there is a drawback that an optimal state is not achieved from the viewpoint of the cross erasure. Thus, this method cannot be also used for a high density optical disc.

In addition, the following methods are known in connection with the track offset correction. Japanese Laid Open Patent Application No. JP-P2000-268385A discloses an information recording/reproducing apparatus that performs track offset correction in recording operations and does not perform track offset correction in reproducing operations. This information recording/reproducing apparatus is provided with a tracking servo circuit, a track center detection circuit, a track correction circuit and a switch circuit. The tracking servo circuit positions an optical beam onto the information track. The track center detection circuit detects the deviation between the center of the information track and the scanning position of the optical beam. The track correction circuit connects a track correction signal obtained by the track center detection circuit to the tracking servo circuit to provide correction of the scanning position of the optical beam. The switch circuit controls the signal connection from the track correction signal to the track correction circuit. The information processing apparatus has a function of turning an and off the switch circuit, allowing the track offset correction to be performed in recording operations and prohibiting the track offset correction in reproducing operations.

Also, Japanese Laid Open Patent Application No. JP-A-Heisei, 11-175990 discloses a method of a track offset correction on the basis of the crosstalk quantity. A record information reproducing apparatus is provided with a tracking error detector and a tracking actuator. The tracking error detector detects a tracking error on the basis of a read signal obtained by electro-optical conversion of a reflection light when an information read beam is emitted to a recording disc. The tracking actuator makes the information read beam follow the record track of the recording disc on the basis of the tracking error. The record information reproducing apparatus performs track offset correction by subtracting from the tracking error the value corresponding to the balance between the crosstalk quantities from the respective recording tracks adjacent to both sides of the recording track targeted for the reading operation.

The error rate (PI error) is often used as an index to indicate the level of the reproduction quality. A brief description is given of the PI error in the following. Data recorded on an optical disc, such as a DVD and an HD DVD, are added with data for error correction in addition to the original data. Generally, such data are referred to as parity. The original data are divided into a number of blocks, and parities are added to the respective blocks. When an error occurs in a specific data block, the occurrence of the error is detected by using the parity added to the specific block. The PI error is a quantity representing the number of data blocks in which errors occur, which is an index strongly correlated with the error rate.

However, the PI error tends to vary depending on tracks, and therefore cannot be used for the adjustment as a matter of practice. FIG. 6 shows the measurement result of the variations depending on tracks, for the PI error and the PRSNR. The portions at which the PI error is abnormally increased are the portions at which defects exist; however, it can be understand that the PRSNR is not substantially changed even in the tracks at which the PI error is abnormally increased. This is because the PI error indicates the data error itself while the PRSNR indicates the quantity representing the quality of the entire signal, which is not so influenced by the defects. When any parameter adjustment is carried out, it is not adequate to use an index which exhibits large variations in the signal quality between the tracks. This is because it cannot be determined whether variations in the index are caused by the deviation of the parameter to be adjusted or by the variations in the tracks. Therefore, it is important to select an index used in performing a high level track offset adjustment. In high density optical discs, such as HD DVDs, in which the standardization is currently advanced, the track offset adjustment is of much importance. However, the conventionally proposed methods do not offer sufficient adjustment accuracy. Hence, an adjustment method with enhanced accuracy is desired.

### DISCLOSURE OF INVENTION

An object of the present invention is to provide a track offset adjustment method with improved accuracy and an information recording/reproducing apparatus which performs track offset adjustment with improved accuracy.

Also, an object of the present invention is to provide a track offset adjustment method and an information recording/reproducing apparatus which suppress a margin reduction in the track offset accompanied by density growth in an information recording medium.

In an aspect of the present invention, a track offset adjusting method of an information recording medium is achieved by: performing a first recording operation which records data onto first and second tracks of the information recording medium, wherein no data are recorded on at least one of tracks adjacent to each of said first and second tracks; performing after said first recording operation a second recording operation which records data on a third track adjacent to the inner circumferential side of said first track and on a fourth track adjacent to the outer circumferential side of said second track; calculating reproduction signal qualities of said first and second tracks on the basis of reproduction signals obtained by reproducing the data recorded on said first and second tracks; and adjusting the track offset on the basis of said reproduction signal qualities of said first and second tracks.

The second recording operation includes recording the data with said track offset varied, the calculating step includes calculating said reproduction signal qualities for different ones of said track offsets, and the adjustment step includes adjusting said track offset so that said reproduction signal qualities of said first and second tracks are equal to each other.

Said adjusting step preferably includes: providing in advance correlation data indicating correlation between said track offset and the difference between reproduction signal qualities of said first and second tracks; and determining the adjustment value of said track offset on the basis of the difference between said reproduction signal qualities of said first and second tracks and said correlation data.

Said third and fourth tracks may be the same track positioned between said first and second tracks.

Also, the above-described reproduction signal qualities may be signal-to-noise ratios (SNRs) of the reproduction signals. The SNRs are calculated by the following equation with a symbol E[ ] indicating an expected value:

$$S = \frac{{( {\sum }_{m} {ɛ}_{m}^{2} )}^{2}}{E [ {( {\sum }_{m} {ɛ}_{m} {n}_{m} )}^{2} ]}$$

where a vector ε is defined as ε=(ε1, ε2, . . . , εm) and a noise n representing the di fference between ideal and actual signal waveforms is defined as n=(n1, n2, . . . , nm).

Moreover, the minimum SNRs may be defined as the reproduction signal qualities out of the SNRs calculated for a plurality of vectors ε. Preferably, the plurality of vectors ε are composed of the following three vectors:

ε1=(1, 2, 2, 2, 1),

ε2=(1, 2, 1, 0, −1, −2, −1), and

ε3=(1, 2, 1, 0, 0, 0, 1, 2, 1).

Also, the SNRs of the present invention may be PRSNRs indicating the SNRs in a PR (Partial Response) system.

In another aspect of the present invention, an information recording/reproducing apparatus is provided with a recording/reproducing unit, a servo controller unit, a signal reproduction unit, a signal comparator unit and a track offset control unit. The recording/reproducing unit records data onto first and second tracks of said information recording medium under the control of the servo controller unit when data are not recorded on at least one of the tracks adjacent to each of said first and second tracks, and then records data onto a third track adjacent to the inner circumferential side of the first track and a fourth track adjacent to the outer circumferential side of the second track. The signal reproduction unit generates reproduction signals from signals reproduced from the first and second tracks by the recording/reproducing unit, after the data are recorded onto the third and fourth tracks. The signal comparator unit calculates reproduction signal qualities of said first and second tracks from said reproduction signals of said first and second tracks to compare the reproduction signal qualities of said first and second tracks. The track offset control unit controls the servo controller unit so that the track offset of the recording/reproducing unit is adjusted on the basis of the comparison result by the signal comparator unit.

The information recording/reproducing apparatus repeats the following operations for each varied track offset, and the track offset adjuster controls the servo controller to adjust the track offset so that the reproduction signal qualities of the first and second tracks are equal:

(a) The recording unit records data onto the first and second tracks and then records data on third and fourth tracks.

(b) The signal reproduction unit reproduces the data recorded on the first and second tracks and then outputs the reproduction signals.

(c) The signal comparator unit calculates the reproduction signal qualities of the first and second tracks on the basis of the reproduction signals.

Also, said track offset control unit is preferably provided with a storage unit for storing correlation data indicating the correlation between said track offset and the difference between said reproduction signal qualities of said first and second tracks. The track offset control unit determines the adjustment value of the track offset on the basis of the correlation data and the difference between the reproduction signal qualities of the first and second tracks.

The above-described third and fourth tracks may be the same track positioned between said first and second tracks. In this case, the recording/reproducing unit records data on the track disposed between the first and second tracks after recording the data on the first and second tracks.

Also, the above-described reproduction signal qualities may be signal-to-noise ratios (SNRs) of the reproduction signals. The SNRs are calculated by the following equation with a symbol E[ ] indicating an expected value:

$$S = \frac{{( {\sum }_{m} {ɛ}_{m}^{2} )}^{2}}{E [ {( {\sum }_{m} {ɛ}_{m} {n}_{m} )}^{2} ]}$$

where a vector ε is defined as ε=(ε1, ε2, . . . , εm) and a noise n representing the difference between ideal and actual signal waveforms is defined as n=(n1, n2, . . . , nm).

Moreover, the minimum SNRs may be defined as the reproduction signal qualities out of to the SNRs calculated for a plurality of vectors ε. Preferably, the plurality of vectors ε are composed of the following three vectors:

ε1=(1, 2, 2, 2, 1),

ε2=(1, 2, 1, 0, −1, −2, −1), and

ε3=(1, 2, 1, 0, 0, 0, 1, 2, 1).

Also, the SNRs of the present invention may be PRSNRs indicating the SNRs in a PR (Partial Response) system.

The present invention provides a track offset adjustment method and an information recording/reproducing apparatus which can quickly adjust the track offset with improved accuracy.

The present invention also provides a track offset adjustment method and the information recording/reproducing apparatus which can suppress the margin decrease in the track offset accompanied by density growth in an information recording medium.

### BRIEF DESCRIPTION OF DRAWINGS

FIG. 1 is a flowchart showing a procedure of a track offset adjustment in an information recording/reproducing apparatus in a first exemplary embodiment of the present invention;

FIGS. 2A and 2B are views showing states of record marks formed on tracks for the information recording/reproducing apparatus of the first exemplary embodiment;

FIG. 3 is a view showing reproduction characteristics of record signals in the information recording/reproducing apparatus according to the first exemplary embodiment;

FIG. 4 is a view showing the difference of the reproduction characteristics of the record signals in the information recording/reproducing apparatus according to the first exemplary embodiment;

FIG. 5 is a flowchart showing a procedure of a track offset adjustment in an information recording/reproducing apparatus of a second exemplary embodiment of the present invention;

FIG. 6 is a view showing track-to-track variations in the PI error and the PRSNR;

FIG. 7 is a block diagram showing the configuration of the information recording/reproducing apparatus according to the present invention;

FIG. 8 is a block diagram showing the configuration of an RF circuit unit in the information recording/reproducing apparatus according to the present invention;

FIG. 9 is a view showing the section of an optical disc used in the information recording/reproducing apparatus according to the present invention;

FIG. 10 is a view showing the states of record marks formed on the tracks of the optical disc used in the information recording/reproducing apparatus according to the present invention; and

FIG. 11 is a flowchart showing a modification of the procedure of the track offset adjustment in the information recording/reproducing apparatus of the second exemplary embodiment of the present invention.

### BEST MODE FOR CARRYING OUT THE INVENTION

The information recording/reproducing apparatus according to the present invention and the track offset adjusting method thereof will be described below in detail with reference to the attached drawings.

A description is first given of the principle of the present invention. When data are recorded onto a track adjacent to an already-recorded track on which data are already recorded, cross erasure occurs on the already-recorded track. The degree of the cross erasure is measured from the reproduction characteristics of the already-recorded track, deferring depending on which of the adjacent tracks of the track are latterly recorded with data. Here, the PRSNR (SNR (Signal to Noise Ratio) of Partial Response Method) is used as the reproduction characteristics. The PRSNR will be described later.

The point optimal for the recording/reproducing is the point at which the PRSNR is the highest when data are recorded onto the tracks adjacent to both sides of the already-recorded track. At this point, the PRSNRs of the respective tracks are equal, which tracks have only one adjacent track recorded. Therefore, the track offset optimal for the recording/reproducing can be determined through measuring the PRSNRs with the data reproduced from the two kinds of tracks which have latterly-recorded adjacent tracks positioned on the opposite sides to each other, and determining the point at which the PRSNRs of the respective tracks are equal.

Next, a brief description is given of the PRSNR used in the present invention. At present, a PRML (Partial Response Maximum Likelihood) signal process has become used even in the optical disc and the PRSNR is the SNR in the PR (Partial Response) system. As the inventors et al. have described in ISOM2003 (International Symposium Optical Memory 2003), S. OHKUBO et al., “Signal-to-Noise Ratio in a PRML Detection”, Japanese Journal of Applied Physics Vol. 43, No. 7B, 2004, pp. 4859-4862, and Japanese Laid Open Patent Application No. JP-P2004-213862A, the PRSNR is obtained by calculating the following formula with respect to the path which is the bottleneck of the system with a short Euclidean distance. When there are multiple bottleneck paths, the PRSNR is obtained by defining the SNR of the PRML system as the value of the path that minimizes the calculation results of the following equation for the respective paths:

$$S = \frac{{( {\sum }_{m} {ɛ}_{m}^{2} )}^{2}}{E [ {( {\sum }_{m} {ɛ}_{m} {n}_{m} )}^{2} ]}$$

Here, E[ ] represents the expected value. The expected value is the value that is expected when the following equation is calculated at each time, and can be considered as the average value. The numerator is just the Euclidean distance between the paths:

$${\sum }_{m} {ɛ}_{m} {n}_{m}$$

Here, the Euclidean distance between the paths represents the difference between the time-series of signal levels. As for the difference between a path with a time-series of the signal levels of (−4, −3, −1, 1, 3) (the values for five time cycles are shown for this case) and a path with a time-series of the signal levels of (−3, −1, 1, 3, 4), for example, the difference between these time series is (1, 2, 2, 2, 1) or (−1, −2, −2, −2, −1). The distance of the difference between these time-series is referred to as the Euclidean distance, which is a vector distance. In this case, the Euclidean distance is calculated as 1×1+2×2+2×2+2×2+1×1=14.

Although the PRSNR is used in this exemplary embodiment, the usual SNR may be measured and used, basically. An index similar to the SNR, such as a jitter, may be measured for both tracks instead of the SNR. It should be noted, however, that the PRSNR is most suitably used for high density discs which uses the PRML, such as HD DVDs, since the PRSNP represents the quality of the reproduction signal best.

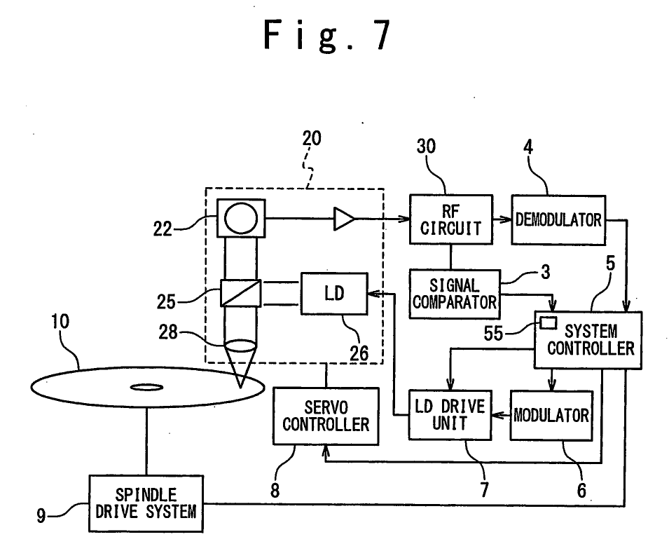

FIG. 7 is a block diagram showing the configuration of the information recording/reproducing apparatus according to the present invention. The information recording/reproducing apparatus records data onto an optical disc 10 and reproduces the data from the optical disc 10. The information recording/reproducing apparatus is provided with a spindle drive system 9, an optical head unit 20, an RF circuit unit 30, a signal comparator 3, a demodulator 4, a system controller 5, a modulator 6, an LD driver 7 and a servo controller 8.

The spindle drive system 9 drives and rotates the optical disc 10. The optical head unit 20, which includes a laser diode (LD) 26, a beam splitter 25, an objective lens 28 and a light receiver 22, emits a laser light to the optical disc 10 and detects the reflected light thereof. The laser light emitted from the laser diode (LD) 26 is reflected by the beam splitter 25 and emitted to the optical disc 10 through the objective lens 28. The reflection light reflected by the optical disc 10 is focused by the objective lens 28 and detected by the light receiver 22 after passing through the beam splitter 25. The input signal detected by the light receiver 22 is outputted to the RF circuit unit 30.

The RF circuit unit 30 performs a process including a filtering process and the like on the input signal, outputting an equalized reproduction signal and a data sequence signal to the signal comparator 3, and outputting the data sequence signal to the demodulator 4. The configuration of the RF circuit unit 30 will be described later. The signal comparator 3 calculates the signal used for the track offset detection based on the equalized reproduction signal and the data sequence signal, which are outputted by the RF circuit unit 30, and outputs the result to the system controller 5.

The demodulator 4 demodulates the data sequence signal outputted by the RF circuit unit 30 to output to the system controller 5. The modulator 6 modulates the signal to be recorded, which is supplied by the system controller 5, to output to the LD driver 7. The LD driver 7 drives the laser diode 26 on the basis of the modulated signal to be recorded, which is inputted from the modulator 6, to record onto the optical disc 10. The servo controller 8 controls the servo signal for controlling the optical head unit 20. Here, a tilt correction mechanism is included.

The system controller 5 obtains the demodulated data from the demodulator 4 and outputs the data to be recorded, to the modulator 6. The system controller 5 entirely manages the information recording/reproducing apparatus, obtaining the signal used for the track offset detection from the signal comparator 3 to instruct the servo controller 8 to perform track offset adjustment, and controlling the spindle drive system 9 and the servo controller 8. The system controller 5 incorporates therein a track offset adjuster for controlling the track offset adjustment.

In the present invention, the signal comparator uses the output from the RF circuit to output the signal for the track offset adjustment. The track offset adjustor is incorporated within the system controller. In this exemplary embodiment, the signal comparator 3 also calculates the PRSNR.

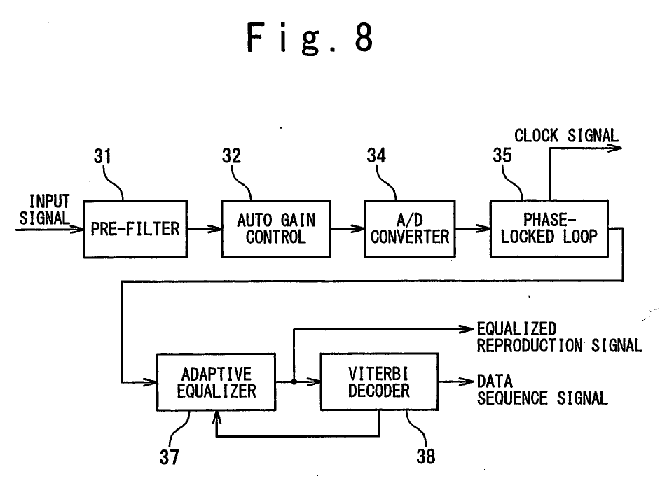

The RF circuit unit 30 receives the signal from the optical head unit 20 to perform processes including filtering, equalizing, PLL and so on. When the PRML is used, the RF circuit unit 30 performs Viterbi decoding and so on. The RF circuit unit 30 is provided with a pre-filter 31, an automatic gain control (AGC) 32, an A/D converter (ADC) 34, a phase locked loop (PLL) 35, an adaptive equalizer 37 and a Viterbi decoder 38, as shown in FIG. 8.

The input signal received from the optical head unit 20 is filtered by the pre-filter 31, and then digitized by the A/D converter 34 after the amplitude control by the automatic gain control 32. A clock signal is extracted from the digitized input signal by the phase locked loop 35 and the digitized input signal is outputted to the adaptive equalizer 37 in synchronization with the channel frequency of the input signal.

The adaptive equalizer 37 modifies the frequency characteristics so that the frequency characteristics of the input signal are close to the PR characteristics. The equalized reproduction signal with the frequency characteristics modified by the adaptive equalizer 37 is outputted to the Viterbi decoder 38 and also outputted to the signal comparator 3. The Viterbi decoder 38 receives the equalized reproduction signal from the adaptive equalizer 37 to convert into binary data. The converted binary data are fed back to the adaptive equalizer 37 and also outputted as the data sequence signal to the signal comparator 3 and the demodulator 4.

The equalized reproduction signal, which is the signal subjected to the adaptive equalization outputted by the adaptive equalizer 37, and the data sequence signal after the Viterbi decoding outputted by the Viterbi decoder 38 are inputted to the signal comparator 3. The signal comparator 3 calculates the PRSNR on the basis of the equalized reproduction signal and the data sequence signal. The noise at each time required in the PRSNR calculation is calculated as the difference between the ideal signal wave form determined on the basis of the data sequence signal after the Viterbi decoding and the actual signal waveform, which is the signal after the adaptive equalization. The ideal signal waveform is determined by the convolution integral between the data sequence signal after the Viterbi decoding and the vector (1, 2, 2, 2, 1).

The signal comparator 3 includes a memory that can store data of two tracks. This memory is able to transiently store the PRSNRs of the respective tracks. When the PRSNRs of the two tracks are calculated, the difference therebetween is determined. The difference between the two tracks is outputted as the track offset detection signal to the system controller 5. On the basis of the track offset detection signal, a track offset adjuster 55 incorporated within the system controller 5 controls the track offset.

In this exemplary embodiment, an example is shown in which the optical head unit 20 has an LD wavelength of 405 nm and an NA (numerical aperture) of 0.65. In addition, the RF circuit unit 30 includes a Viterbi decoder for PR (12221) in this example.

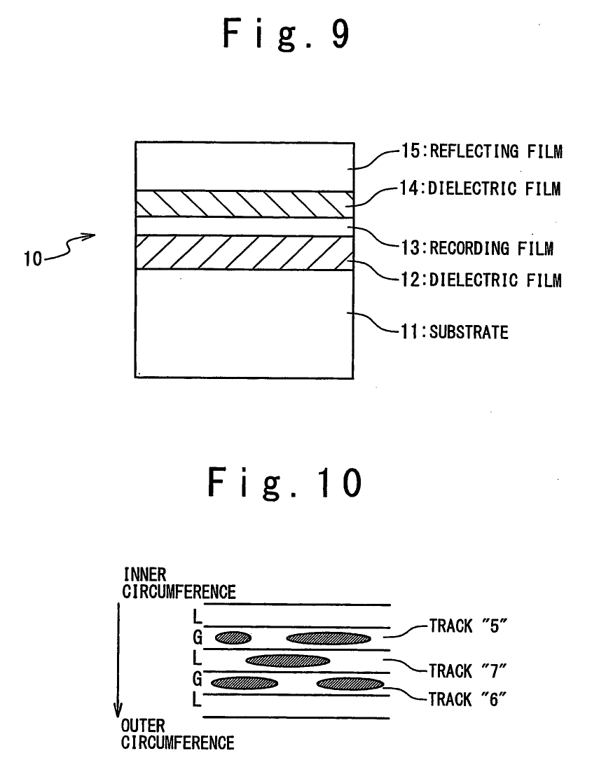

On the other hand, the optical disc 10 includes a lamination structure as shown in FIG. 9. The optical disc 10 includes a dielectric film 12, a phase change recording film 13, a dielectric film 14 and a reflection film 15, which are successively laminated on a substrate 11. The substrate 11 is a transparent circular plate made of polycarbonate which has a thickness of 0.6 mm and a diameter of 12 cm. A guide groove (not shown), which is referred to as the pre-groove, is formed on the substrate 11. This guide groove is structured so as to allow scanning the optical beam of the optical information recording apparatus, namely, the optical disc drive along the guide groove in recording and reproducing operations. The dielectric film 12 made of ZnS—SiO₂, the phase change recording film 13 made of AgInSbTe, the dielectric film 14 made of ZnS—SiO₂ and the reflection film 15 made of AlTi are laminated in this order on the substrate 11.

The dielectric films 12 and 14 aim at the protection of the phase change recording film 13 and the control of the interference condition of the laser light to obtain an increased signal. The phase state of the phase change recording film 13 is crystalline in the initial state; data are recorded by changing the phase state into the amorphous state with the radiation of a recording laser light. It should be noted that a protecting film made of ultraviolet curing resin and the like may be formed on the reflection film 15.

As the format, the land groove format is used in which the bit pitch is 0.13 μm and the track pitch is 0.34 μm. The land groove format is the format in which the recording is performed on both of the hill (groove) portion and the groove (land) portion, when viewed from the incident light side of the aforementioned guide groove.

### First Exemplary Embodiment

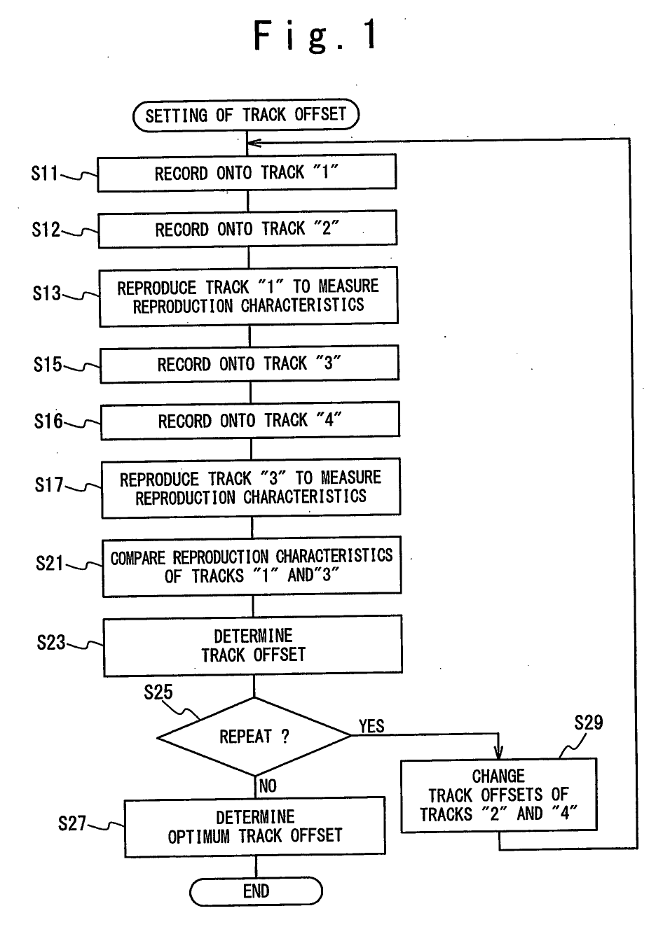

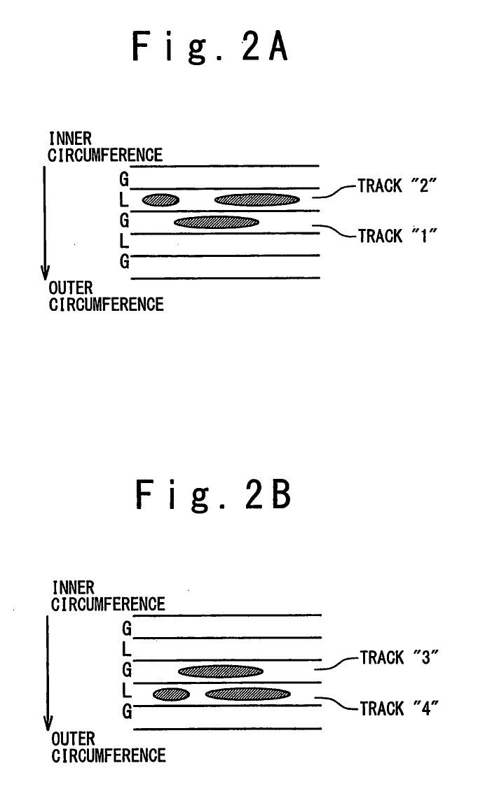

An information recording/reproducing apparatus thus constructed adjusts the track offset, in accordance with the processing procedure shown in FIG. 1. After the optical disc 10 is inserted into the information recording/reproducing apparatus, data are firstly recorded onto a track “1” at a desired radius position, wherein no record marks are recorded on adjacent tracks positioned on both sides of the track “1” (Step S11). This is followed by recording data onto a track “2” adjacent to the inner circumferential side of the track “1” to develop the states of the record marks as shown in FIG. 2A (Step S12). After that, the data recorded on the track 1 are reproduced, and the reproduction characteristics are measured (Step S13). Here, the signal comparator 3 calculates the PRSNR on the basis of the reproduced signal, and holds the calculated PRSNR.

Data are then recorded on a track “3”, wherein no record marks exist on the tracks adjacent to both sides of the track “3” (Step S15). Next, data are recorded on a track “4” adjacent to the outer circumferential side of the track “3” (Step S16) to develop the states of the record marks as shown in FIG. 2B. After that, the data recorded on the track “3” are reproduced, and the reproduction characteristics are measured (Step S17). Here, the signal comparator 3 calculates the PRSNR on the basis of the reproduced signal, and holds the calculated PRSNR.

After the reproduction characteristics of the tracks “1” and “3” are measured, the signal comparator 3 calculates the difference between the PRSNR in the track 1 and the PRSNR in the track 3 and sends the difference as a track offset detection signal to the system controller 5 (Step S21). The track offset adjuster 55 incorporated within the system controller 5 determines the presence or absence of the track offset based on the track offset detection signal (Step S23).

If the track offset detection signal does not have a desirable value (Step S25—Yes), the track offset adjuster 55 feeds instructions to the servo controller 8 to change the track offsets of the tracks “2” and “4” (Step S27). The servo controller 8 changes the track offsets in accordance with the instructions. After that, the operations from the step S11 to the step S23 are repeated until the track offset detection signal is set to a desired value. If the track offset detection signal is set to a desired value (Step S25—No), the track offset adjuster 55 determines that the track offset value at that time is the optimal track offset value, and sets the optimal track offset value to be kept in the servo controller 8, completing the track offset adjustment (Step S29).

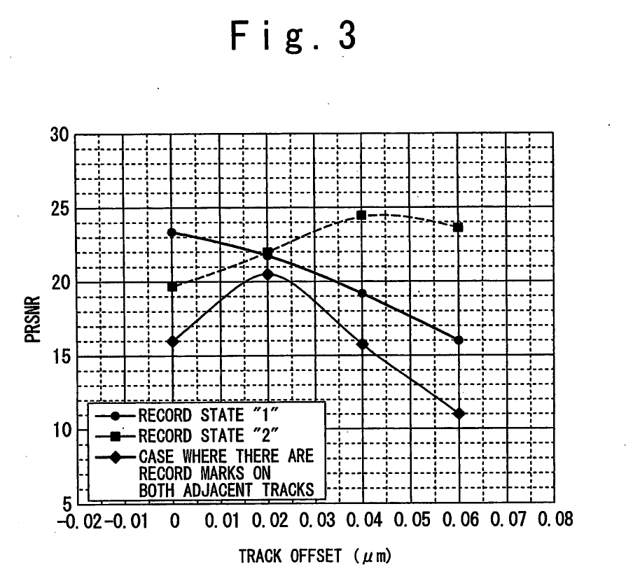

In this way, the graph shown in FIG. 3 is obtained when the changes in the PRSNRs in the tracks “1” and “3” are plotted with the track offsets of the tracks “2” and “4” varied. In this case, the track offset of 0.02 μm is the track offset optimal for the cross erasure, which achieves the optimal recording/reproducing for the optical disc 10. This is understood from the fact that the PRSNR of the track for which data are recorded on both of the tracks adjacent thereto shown in FIG. 3 indicates the maximal value. It is also understood that the PRSNR values of the tracks “1” and “3” are equal at this condition. That is, the adjustment to the optimal track offset can be achieved by implementing the foregoing operations and selecting the track offset so that the PRSNR values of the tracks “1” and “3” are equal.

Next, a practical investigation as the information recording/reproducing apparatus of the present invention is given. An information recording/reproducing apparatus, usually sets the track offset to 0 in performing the recording/reproducing when the track offset is not adjusted. At first, the error rate was measured in this state with the optical disc inserted into the information recording/reproducing apparatus; the result was an error rate of 5.5×10⁻⁵. The error rate suffers from severe variations depending on the tracks, and therefore the measurement was performed for 1000 tracks. It should be noted that the PRSNR at this time was about 15.

This was followed by implementing a similar experiment with the track offset adjusted by the adjusting method of the present invention. The result was that the error rate was 5.0×10⁻⁶ and the PRSNR was about 20. It is understood from this result that the recording/reproducing performance was largely improved by the present invention. It should be noted that the learned track offset value was 0.02 μm.

As thus described, the present invention achieves quick adjustment of the track offset with improved accuracy. This exemplary embodiment described with reference to FIGS. 1 and 2 is an example directed to the land groove format in which the track offset of the land is adjusted. In general, the track offset of the groove is similarly adjusted thereafter. In this case, it is obviously understood that the same goes for the case with the notifications of the land and groove interchanged in FIGS. 1 and 2. Also, it would be naturally understood that the present invention is applicable to the in-groove format. In that case, the modification only includes the fact that all of the tracks “1”, “2”, “3” and “4” are made of grooves.

### Second Exemplary Embodiment

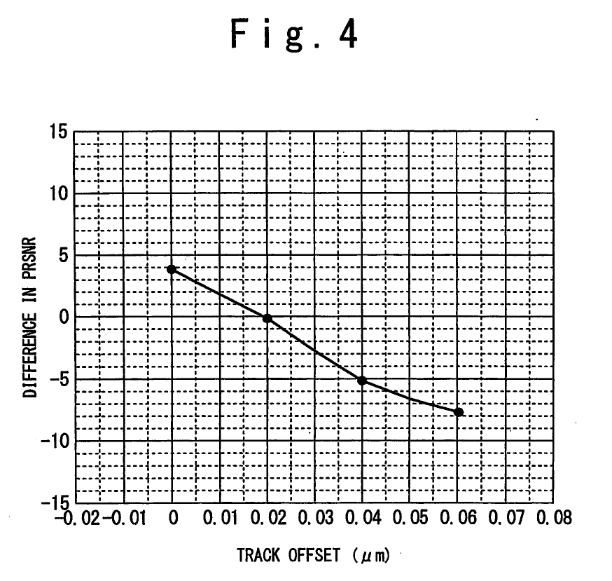

FIG. 4 shows the difference between the PRSNR values of the tracks “1” and “3” in FIG. 3. As can be understood from FIG. 4, the track offset is deviated in the negative direction from the optimal value, when the difference is positive, and vice versa when the difference is negative. Therefore, the use of FIG. 4 allows determining in which direction the track offset is deviated, thereby enabling the track offset to be easily adjusted. Since the correlation between the track offset and the PRSNR difference shown in FIG. 4 exhibits an approximately linear dependency, the deviation amount of the track offset can be also estimated from the PRSNR difference. Hence, the track offset adjustment can be instantly completed after the PRSNRs of the tracks “1” and “3” are measured only once, when the characteristics shown in FIG. 4 are preliminarily set to the information recording/reproducing apparatus.

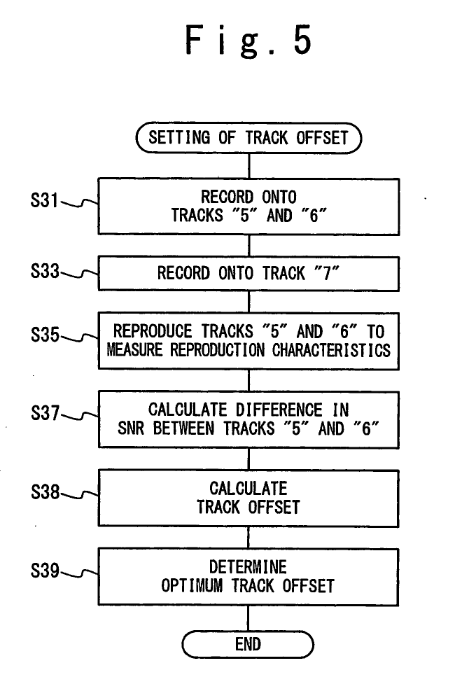

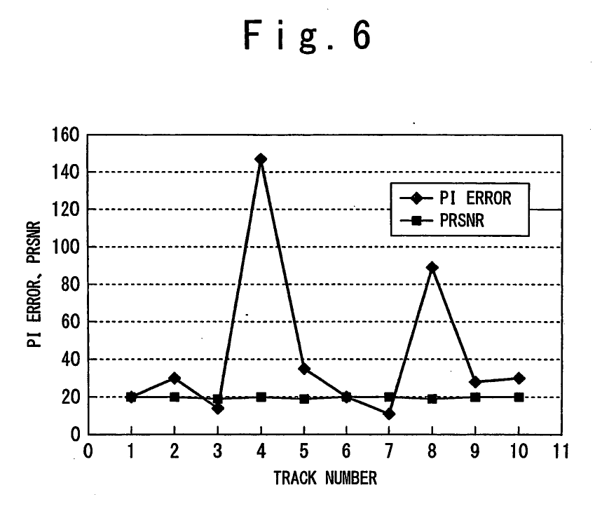

The track offset adjustment in this case is carried out in accordance with the processing procedure shown in FIG. 5. The configurations of the information recording/reproducing apparatus and the optical disc, which are shown in FIGS. 7 and 9, respectively, are same as those in the first exemplary embodiment. In this exemplary embodiment, as shown in FIG. 7, the tracks on which the PRSNR measurement is performed are only two tracks “5” and “6”, between which a track 7 where the data is to be recorded later is disposed and for which no record marks are recorded on tracks adjacent to both sides thereof.

When the optical disc 10 is inserted into the information recording/reproducing apparatus, data are recorded on the tracks “5” and 6 between which the track “7” is disposed and for which no record marks are recorded on tracks adjacent to both sides thereof (Step S31). Subsequently, data are recorded on the track “7” disposed between the tracks “5” and “6” (Step S33) to develop the states of the record marks as shown in FIG. 10. After that, the data recorded on the tracks “5” and “6” are reproduced, and the signal comparator 3 measures the reproduction characteristics of the respective tracks (Step S35). In this exemplary embodiment, the signal comparator 3 calculates the PRSNRs of the reproduction signals of the respective tracks, as the reproduction characteristics. The signal comparator 3 calculates the difference therebetween and sends the PRSNR difference as the track offset detection signal to the system controller 5 (Step S37).

The track offset adjuster 55 incorporated within the system controller 5 calculates the track offset from the track offset detection signal on the basis of the correlation between the PRSNR difference and the track offset shown in FIG. 4 (Step S38). The track offset adjuster 55 may contain the correlation shown in FIG. 4 as a table or may have as a linearly approximated calculation equation.

After the track offset is determined in the measurement, the track offset adjuster 55 judges the degree and direction of the deviation with respect to the optimal track offset and determines the value to be instructed in order to achieve the optimal track offset. The track offset adjuster 55 indicates to the servo controller 8 the value determined so that the optimal track offset is achieved, and changes the track offset (Step S39). In this way, the track offset is adjusted.

As thus described, the second exemplary embodiment offers efficient track offset adjustment, omitting the procedure of changing the track offset in adjusting the track offset to the optimal value. In addition, the second exemplary embodiment is further efficient, since the record marks generated when data are recorded on the three tracks are used to adjust the track offset as shown in FIG. 10. It should be noted that a practical investigation similar to the first exemplary embodiment has confirmed that the performance comparable to the first exemplary embodiment is obtained in the second exemplary embodiment.

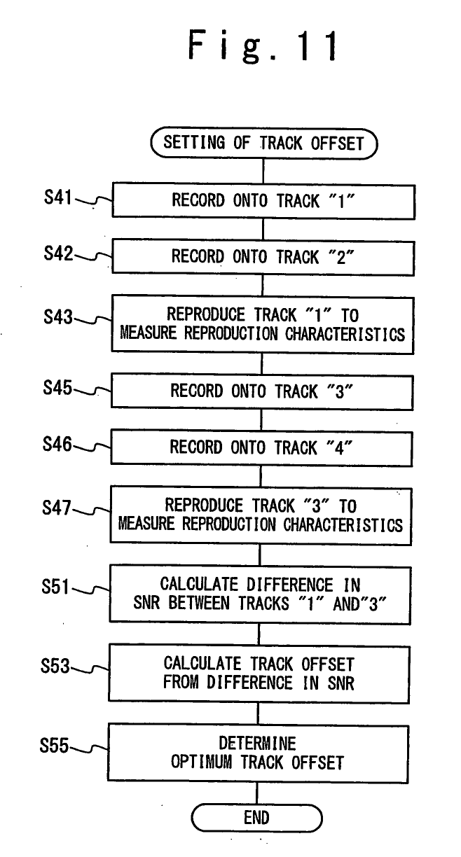

The use of the states of the record marks shown in FIG. 2 instead of the states of the record marks shown in FIG. 10 also allows implementing the track offset adjustment through the method in which the track offset is determined from the PRSNR difference. In this case, the processing procedure shown in FIG. 11 is used to perform the track offset adjustment.

After the optical disc 10 is inserted into the information recording/reproducing apparatus, data are first recorded on a track “1” at a desired radius position, wherein no record marks are recorded on tracks adjacent to both sides of the track “1” (Step S41). Subsequently, data are recorded on the track “2” adjacent to the inner circumferential side of the track “1” to develop the states of the record marks as shown in FIG. 2A (Step S42). After that, the data recorded on the track “1” are reproduced, and the reproduction characteristics are measured (Step S43). Here, the signal comparator 3 measures the PRSNR based on the reproduced signal.

Subsequently, data are recorded on the track “3” for which no record marks exist on the tracks adjacent to both sides thereof (Step S45). Next, data are recorded on the track “4” adjacent to the outer circumferential side of the track “3” to develop the states of the record marks as shown in FIG. 2B (Step S46). After that, the data recorded on the track “3” are reproduced, and the reproduction characteristics are measured (Step S47). Here, the signal comparator 3 measures the PRSNR based on the reproduced signal.

After the reproduction characteristics of the tracks “1” and “3” are measured, the signal comparator 3 calculates the difference between the PRSNR in the track “1” and the PRSNR in the track “3”. The calculated PRSNR difference is sent as the track offset detection signal to the system controller 5 (Step S51). The track offset adjuster 55 incorporated within the system controller 5 calculates the track offset based on the track offset detection signal (Step S53). The correlation between the track offset and the PRSNR is linear as shown in FIG. 4, and therefore the track offset adjustor 55 may incorporate therein the correlation in a form of a calculation equation or in a form of a table.

After the track offset is determined in the measurement, the track offset adjuster 55, which can instantly calculate the degree and direction of the deviation with respect to the optimal track offset, determines the value to be instructed in order to attain the optimal track offset. The track offset adjuster 55 indicates to the servo controller 8 the value determined so that the optimal track offset is achieved, to thereby change the track offset (Step S55). In this way, the track offset is adjusted.

Although the PRSNR is used as the SNR in this exemplary embodiment as described above, various SNRs, including a simple SNR calculated with ε=(1) and so on, may be used in implementations. Also, the present invention is not limited to the wavelength of 405 nm and the NA of 0.65; the present invention is applicable to all the wavelengths and the NAs.

Although the class of PR (12221) is used in the above-mentioned exemplary embodiments, other classes, such as PR (1221), may be similarly used. Although the case where the PRML is used is described in the above-mentioned exemplary embodiments, the present invention may be similarly applied in a system in which the PRML is not used.

Although one example of a rewritable type optical disc is presented in the above-mentioned exemplary embodiments, the present invention may be applied to a write-once-read-many optical disc (such as an HD DVD-R) in which the recording can be executed only once. Moreover, although the example is given for an optical disc apparatus, the present invention may be used as a method of correcting the signal quality deterioration caused by the inclination between the head plane and disc plane in a magnetic disc apparatus.

1. An information recording medium track offset adjustment method comprising:
performing a first recording operation which records data onto first and second tracks of an information recording medium, wherein no data are recorded on at least one of tracks adjacent to each of said first and second tracks;
performing after said first recording operation a second recording operation which records data onto a third track adjacent to an inner circumferential side of said first track and onto a fourth track adjacent to an outer circumferential side of said second track;
calculating reproduction signal qualities of said first and second tracks based on reproduction signals obtained by reproducing data recorded on said first and second tracks; and
adjusting a track offset based on said reproduction signal qualities of said first and second tracks.

2. The information recording medium track offset adjustment method according to claim 1, wherein said second recording operation includes recording data with said track offset varied,
wherein said calculating includes calculating said reproduction signal qualities for different values of said track offset,
wherein said adjusting includes adjusting said track offset so that said reproduction signal qualities of said first and second tracks are equal to each other.

3. The information recording medium track offset adjustment method according to claim 1,
wherein said adjusting includes:
providing in advance correlation data indicating correlation between said track offset and a difference between reproduction signal qualities of said first and second tracks; and
determining an adjustment value of said track offset based on a difference between said reproduction signal qualities of said first and second tracks and said correlation data.

4. The information recording medium track offset adjustment method according to claim 1, wherein said third and fourth tracks are a same track positioned between said first and second tracks.

5. The information recording medium track offset adjustment method according to claim 1, wherein said reproduction signal qualities are signal-to-noise ratios (SNRs) of said reproduction signals.

6. The information recording medium track offset adjustment method according to claim 5, wherein said SNRs are calculated by the following equation with a symbol E[ ] indicating an expected value:
$$S = \frac{{( {\sum }_{m} {ɛ}_{m}^{2} )}^{2}}{E [ {( {\sum }_{m} {ɛ}_{m} {n}_{m} )}^{2} ]}$$
where a vector ε is defined as ε=(ε1, ε2, . . . , εm) and a noise n representing a difference between ideal and actual signal waveforms is defined as n=(n1, n2, . . . , nm).

7. The information recording medium track offset adjustment method according to claim 6, wherein minimum SNRs are selected as said reproduction signal qualities out of said SNRs calculated for a plurality of vectors ε.

8. The information recording medium track offset adjustment method according to claim 7, wherein said plurality of vectors ε are:
ε1=(1, 2, 2, 2, 1),
ε2=(1, 2, 1, 0, −1, −2, −1), and
ε3=(1, 2, 1, 0, 0, 0, 1, 2, 1).

9. The information recording medium track offset adjustment method according to claim 5, wherein said SNRs are PRSNRs indicative of SNRs in a PR (Partial Response) system.

10. An information recording/reproducing apparatus comprising:
a recording/reproducing unit for recording data onto tracks of an information recording medium; and
a servo controller unit for controlling a tracking position of said recording/reproducing unit, wherein, under a control of said servo controller unit, said recording/reproducing unit records data onto first and second tracks of said information recording medium where no data are recorded on at least one of tracks adjacent to each of said first and second tracks, and said recording/reproducing unit then records data onto a third track adjacent to an inner circumferential side of said first track and onto a fourth track adjacent to an outer circumferential side of said second track;
a signal reproduction unit generating reproduction signals from signals reproduced from said first and second tracks by said recording/reproducing unit;
a signal comparator unit calculating reproduction signal qualities of said first and second tracks from said reproduction signals of said first and second tracks to compare the reproduction signal qualities of said first and second tracks; and
a track offset control unit controlling said servo controller unit so that a track offset of said recording/reproducing unit is adjusted based on a comparison result by said signal comparator unit.

11. The information recording/reproducing apparatus according to claim 10, wherein said track offset control unit controls said servo controller unit so as to vary said track offset for a position on tracks while said recording/reproducing unit records data onto said third and fourth tracks, and controls said servo controller unit so that the reproduction signal qualities of the first and second tracks are equal.

12. The information recording/reproducing apparatus according to claim 10, wherein said track offset control unit includes a storage unit storing correlation data indicating correlation between said track offset and a difference between said reproduction signal qualities of said first and second tracks, and determines an adjustment value of said track offset based on said difference between the reproduction signal qualities of the first and second tracks and said correlation data.

13. The information recording/reproducing apparatus according to claim 10, wherein said third and fourth tracks are a same track positioned between said first and second tracks.

14. The information recording/reproducing apparatus according to claim 10, wherein said reproduction signal qualities are signal-to-noise ratios (SNRs) of said reproduction signals.

15. The information recording/reproducing apparatus according to claim 14, wherein said SNRs are calculated by the following equation with a symbol E[ ] indicating an expected value:
$$S = \frac{{( {\sum }_{m} {ɛ}_{m}^{2} )}^{2}}{E [ {( {\sum }_{m} {ɛ}_{m} {n}_{m} )}^{2} ]}$$
where a vector ε is defined as ε=(ε1, ε2, . . . , εm) and a noise n representing a difference between ideal and actual signal waveforms is defined as n=(n1, n2, . . . , nm).

16. The information recording/reproducing apparatus according to claim 15, wherein minimum SNRs are selected as said reproduction signal qualities out of said SNRs calculated for a plurality of vectors ε.

17. The information recording/reproducing apparatus according to claim 16, wherein said plurality of vectors ε are:
ε1=(1, 2, 2, 2, 1),
ε2=(1, 2, 1, 0, −1, −2, −1), and
ε3=(1, 2, 1, 0, 0, 0, 1, 2, 1).

18. The information recording/reproducing apparatus according to claim 14, wherein said SNRs are PRSNRs indicative of SNRs in a PR (Partial Response) system.
